(19) United States
(12) Patent Application Publication
(10) Pub. No.: US 2003/0202100 A1
(43) Pub. Date: Oct. 30, 2003

(54) Image-forming device with external activity-recording camera

(76) Inventor: Michael P. Prenn, Star, ID (US)

Correspondence Address: HEWLETT-PACKARD COMPANY, Intellectual Property Administration, P.O. Box 272400, Fort Collins, CO, 80527-2400, US

(21) Appl. No.: 10/136,009

(22) Filed: Apr. 29, 2002

(51) Int. Cl. H04N 7/18

(52) U.S. Cl. 348/155; 340/568.1

(57) ABSTRACT

An image-forming device with an external activity-recording camera is disclosed. The image-forming device includes a case, a printing mechanism disposed within the case, and the camera. The camera is disposed at the case, and is event-driven to record external activity around the image-forming device.

### FIELD OF THE INVENTION

The present invention relates generally to image-forming devices.

### BACKGROUND OF THE INVENTION

Printers have become almost necessary peripherals for most computer users, especially business users. They allow users to print output onto a variety of different print media, primarily paper. There are a number of different types of printers, for different kinds of users and different types of printing needs. Laser printers, for instance, have traditionally been used primarily by businesses that require high-speed black-and-white output. Inkjet printers, by comparison, are generally more popular among home users, since these printers can output color, and are less expensive to purchase. Other types of printers, such as dye-sublimation printers, plotter printers, and impact printers, among others, are used for more specialized tasks.

In business environments, a printer is usually shared among a number of users. For example, in an office environment, all the users on a given floor of a building may share a handful of printers. The printers are connected to the network to which the users' computers are also connected. Users typically have the ability to thus send print jobs to a number of different printers. A user is likely to send a print job to the physically closest printer, but if that printer is malfunctioning, or for another reason, the user may decide to send the print job to another printer. Having a small number of printers shared among a larger number of users is cost-effective for businesses while not substantially affecting productivity, since at any given time, most users are not printing print jobs.

However, shared printers can present security risks. Although most print jobs do not contain sensitive information that should not be shared with other employees, many print jobs do. For example, human resources-related print jobs in almost any organization typically include private information regarding salaries, performance reviews, health conditions, and so on. Furthermore, in some organizations, such as doctor's offices and banking institutions, many print jobs will contain sensitive health information regarding patients, sensitive financial information regarding customers, and so on. When a print job is output at a shared printer, there is great opportunity for someone other than the originator of the print job to pick it up from the printer's output tray, either accidentally or on purpose. Sensitive information can thus be improperly divulged.

Current solutions usually fall into two general categories, and a third solution that is less widely used. Each has disadvantages, however. First, a user who sends a print job with sensitive information to a printer may immediately go to the printer to wait to pick up the print job as it is printed. This solution, however, is inconvenient at best for the user, and may be unrealistic. For example, important phone calls or chance meetings in the hallway with other employees may delay the user from picking up the print job. Second, a number of printers may be located in secure locations for print jobs containing sensitive information. For example, a human resources director may have a printer in his or her office. This solution, however, is also unrealistic. At some point, nearly all employees are likely to generate print jobs with sensitive information, and not all of them can likely be given their own printers for cost reasons. The printer can also be located in a room with limited-employee access using passkeys, locks, and so on. However, this is usually not a productive use of the printer, since the number of employees that can use it is limited.

Third, an employee may send a stored print job to a shared printer that is rendered to a hard disk drive contained within the printer. The employee may then command the printer to actually print the stored print job by entering a pin code assigned to that employee to access the print job. However, this approach is not widely used. Hard disk drives may get full or crash. Furthermore, users may develop lax habits regarding maintaining the confidentiality and security of their pin codes. Other users may have pin codes but not use them when printing, since using them is generally less convenient than simply sending a print job to the printer and physically retrieving it from the output tray.

For these and other reasons, therefore, there is a need for the present invention.

### SUMMARY OF THE INVENTION

The present invention relates to an image-forming device with an external activity-recording camera. An image-forming device of an embodiment of the present invention includes a case, an image-forming mechanism disposed within the case, and an event-driven camera disposed at the case to record external activity around the image-forming device. A method of an embodiment of the present invention detects a predetermined event, and in response thereto records external activity around an image-forming device, as data.

A computer-readable medium of an embodiment of the present invention has a computer program stored thereon to perform a method. The method detects external activity around an image-forming device by a motion detector disposed at the image-forming device, and detects utilization of a user-activated control or a user-operable mechanism of the image-forming device. In response to detecting either, the method records the external activity around the image-forming device with a camera, as data. The data is stored and a user is enabled to review the data.

An image-forming device according to various embodiments of the invention permits print jobs containing sensitive information to be sent to shared printers without considerable concern that they may be accidentally or purposefully taken by the wrong user, since the printer's camera will record such activity. Furthermore, in the situation where the wrong user does pick up a print job that contains sensitive information, the individual can be ascertained by reviewing the recording of this activity. Thus, an inquiry can be made into whether the user accidentally picked up the wrong print job, or purposefully picked up the wrong print job, and the print job can also be recovered.

### BRIEF DESCRIPTION OF THE DRAWINGS

FIGS. 1A, 1B, and 1C are diagrams depicting how external activity around a printer is recorded by a camera, according to varying embodiments of the present invention.

FIG. 2 is a diagram of a system according to an embodiment of the present invention.

FIG. 3 is a block diagram of a printer having an event-driven camera, according to an embodiment of the present invention.

FIG. 4 is a flowchart of a method according to an embodiment of the present invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced.

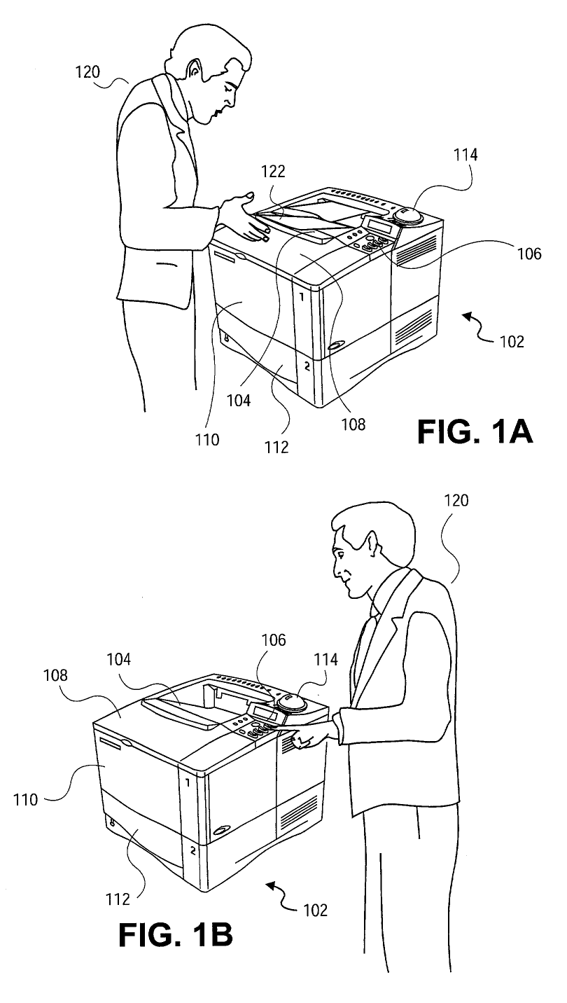

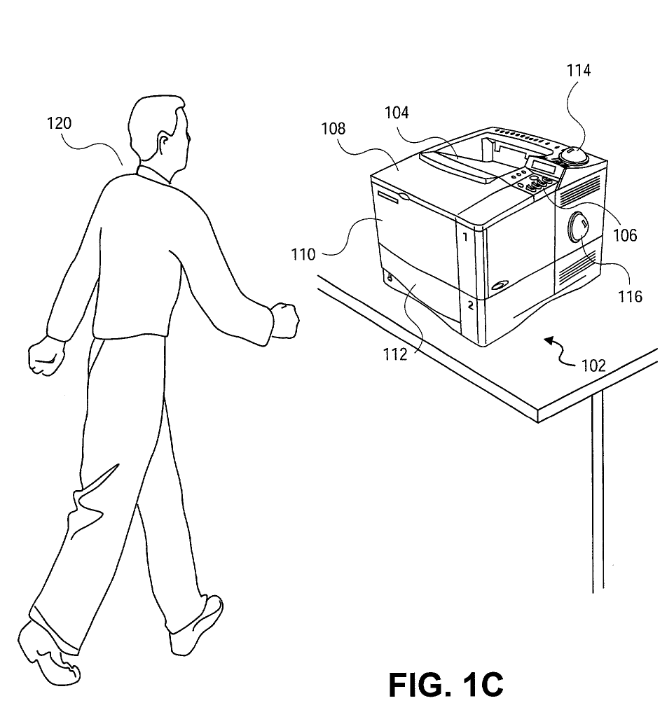

FIGS. 1A, 1B, and 1C show different scenarios in which external activity around a printer is recorded, according to varying embodiments of the present invention. External activity is generally and non-restrictively defined herein as the activity within a limited distance around the printer, in one or more directions. In FIG. 1A, the printer 102 is shown as having an output tray 104, a control panel 106 having a number of user-activated controls, an openable lid 108, a drop-down tray 110, and a paper drawer 112. The printer 102 may vary from that shown in FIG. 1A, and the printer 102 as shown in FIG. 1A is for example purposes only. The output tray 104, the openable lid 108, the drop-down tray 110, and the paper drawer 112 are examples of user-operable mechanisms of the printer 102. However, the printer 102 may also include user-operable mechanisms other than those shown in FIG. 1A.

The printer 102 also includes an event-driven camera hidden behind the opaque bubble 114. As shown in FIG. 1A, the opaque bubble 114 is located on the top side of the printer 102, behind the controls 106. However, the bubble 114, and thus the event-driven camera that it contains, may be located elsewhere on the printer 102. In general, it is said that the event-driven camera is disposed at the case of the printer 102. The case of the printer 102 generally and non-restrictively includes all the external surfaces of the printer 102. The case encloses a printing mechanism of the printer 102, not shown in FIG. 1A, that actually performs the printing. This printing mechanism may be a laser printing mechanism, an inkjet printing mechanism, or another type of printing mechanism. In general, it is said that the printing mechanism is disposed within the case of the printer 102.

In FIG. 1A, the user 120 is picking up a print job 122 that has been output by the printing mechanism of the printer 102 on the output tray 104 of the printer 102. Thus, the user 120 is effectively utilizing one of the user-operable mechanisms of the printer 102, namely the output tray 104, where the printer 102 is likely able to sense when print jobs have been removed from the output tray 104, or at least when the output tray 104 is fall. This utilization of a user-operable mechanism of the printer 102 is an event that causes the camera hidden behind the bubble 114 to record the external activity around the printer 102, such as the activity of the user 120 picking up the print job 122. The camera is preferably a digital camera. It may be a digital video camera that records a duration of video, or moving images, of the external activity, or it may be a digital still camera that records one or more pictures, or still images, of the external activity.

In FIG. 1B, a different type of event that triggers the camera hidden behind the bubble 114 to record the external activity around the printer 102 is shown. Specifically, the user 120 in FIG. 1B is utilizing or activating one of the user-activated controls on the control panel 106. The printer 102 preferably includes such a control panel so that various configuration settings, and other types of settings and controls, may be set by users at the printer 102 itself. Thus, the utilization of the user-activated controls on the control panel 106 is an event that causes the camera hidden behind the bubble 114 to record the external activity around the printer 102. This external activity in FIG. 1B is namely the user 120 utilizing the controls on the control panel 106.

In FIG. 1C, the printer 102 is shown as also including another bubble 116. A motion detector is hidden behind the bubble 116. The motion detector detects motion around the printer 102 to a limited distance. Thus, the motion detector detects the user 120 approaching the printer 102 in FIG. 1C. The detecting of motion by the motion detector behind the bubble 116 is another event that causes the camera hidden behind the bubble 114 to record the external activity around the printer 102. This external activity in FIG. 1C is specifically the user 120 approaching the printer 102.

The bubble 114 as depicted in FIGS. 1A-1C, and the bubble 116 in FIG. 1C, are fairly conspicuous, such that the user 120 is likely to be able to determine that they hide the camera and the motion detector. Alternatively, however, the camera and the motion detector may be more hidden, such that they are likely to be substantially undetectable by the user 120. Furthermore, for security and other reasons, both the camera and the motion detector can be tamper-proof, so that they are not easily disabled or otherwise broken.

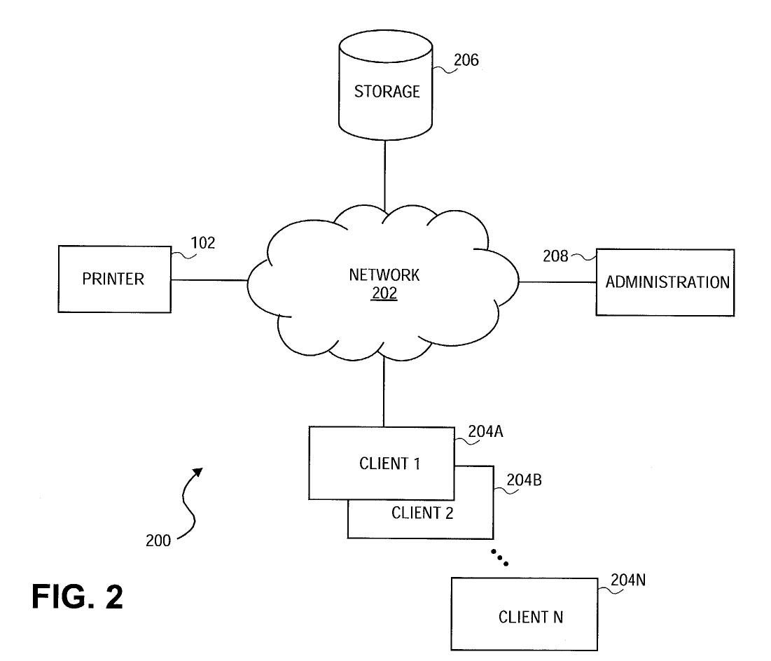

FIG. 2 shows a system 200 including the printer 102, according to an embodiment of the present invention. The printer 102 receives print jobs for printing from the clients 204A, 204B, . . . , 204N, over the network 202. The printer 102 and the clients 204A, 204B, . . . , 204N are each communicatively coupled to the network 202, such as via a network adapter card. The network 202 is preferably a local-area network (LAN). However, the network 202 may also be, in addition to or in lieu of a LAN, a wide-area network (WAN), an extranet, an intranet, the Internet, as well as other types of networks. Each of the clients 204A, 204B, . . . , 204N may be a computer, such as a desktop or a laptop computer, or another type of computerized device, such as a cellular phone, a personal-digital assistant (PDA) device, and so on.

The printer 102 thus prints the print jobs received from the clients 204A, 204B, . . . , 204N. The users of these clients then likely come over to the printer 102 to pick up the printed print jobs. When they do, the printer 102 may record the external activity around the printer 102 in response to an event, such as one of the events that have been described in conjunction with FIGS. 1A-1C in the previous section of the detailed description. The external activity is recorded by the camera of the printer 102 as data. The data may represent still images or video, depending on the type of camera, in any of a number of different file formats.

The printer 102 then preferably timestamps the resulting data file with the current time and date, compresses the data file, and sends it to the storage 206 over the network 202. The storage 206 is also communicatively coupled to the network 202, and may be a server having a hard disk drive or other type of storage device, a network-attached storage (NAS) device, or another type of storage. Alternatively, the printer 102 may have built-in storage on which it can save the resulting data file. In such an instance, the printer 102 does not have to send the data file over the network 202 for storage, but just has to store the data file itself.

The administration node 208 is a special instance of one of the clients 204A, 204B, . . . , 204N. The node 208 is the client from which a network administrator or another individual with special privileges can access the data files generated by the printer 102 and stored at the storage 206. The node 208 is communicatively coupled to the network 202. It may be a permanent node in that the node 208 itself has special security certificates installed thereon that always allow for such access. Alternatively, it may be a temporary node, such as any of the clients 204A, 204B, . . . , 204N on which the network administrator is currently logged.

The administrator can access the stored data files in one of two different ways. First, the administrator, from the administration node 208, may directly access the data files over the network 202 at the storage 206, by having the proper rights or passwords, and so on, necessary to retrieve the data files. The data files may be categorized by date and/or time. Second, the administrator, again from the administration node 208, may access the data files over the network through the printer 102. For instance, the printer 102 may have an embedded server that the administrator logs onto, where the embedded server presents the data files as stored either internally or at the storage 206.

Thus, if a situation occurs such that the administrator needs to determine the external activity around the printer 102 at a given time, he or she can access the data files generated by the printer 102 from the administration node 208. Where the data files are timestamped, the administrator can easily determine if there are data files associated with the date and time in which the administrator is interested. The administrator can therefore determine more easily who has accidentally or purposefully picked up a sensitive print job from the printer 102 that does not belong to him or her.

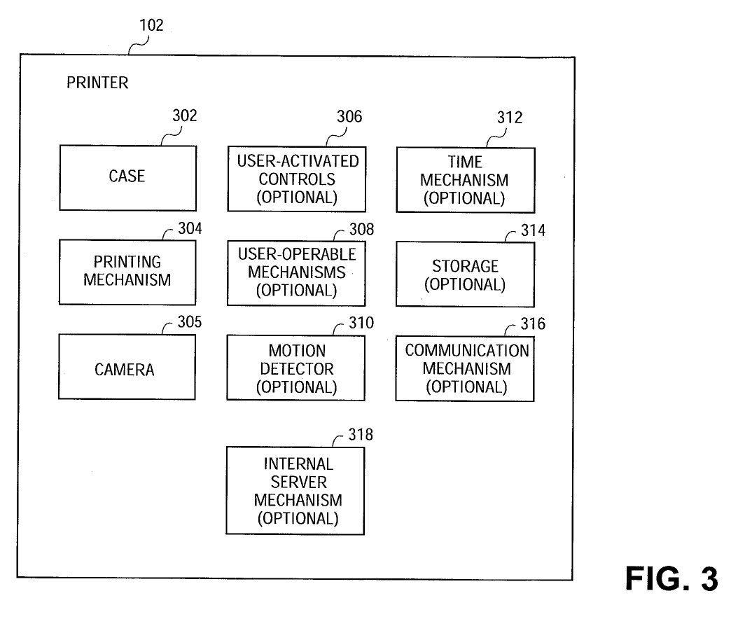

FIG. 3 shows a block diagram of the printer 102 in more detail, according to an embodiment of the present invention. The printer 102 includes at least a case 302, a printing mechanism 304, and an event-driven camera 305. The case 302 includes the outside surfaces of the printer 102, such that the printing mechanism 304 is disposed within the case 302. As has been indicated, the printing mechanism 304 may be a laser printing mechanism, an inkjet printing mechanism, or another type of printing mechanism. The camera 305 may be a digital camera, such as a digital still camera, a digital video camera, or another type of camera. The camera 305, as well as the other components of the printer 102, may be said to be disposed at and/or within the case 302.

Optional components of the printer 102 include the user-activated controls 306, the user-operable mechanisms 308, and the motion detector 310. Each of these components can generate events that cause the camera 305 to record the external activity around the printer. The user-activated controls 306 are controls by which users can access or change settings of the printer 102. Activation of any of the user-activated controls 306 may constitute an event that causes the camera 305 to record activity. The user-operable mechanisms 308 include paper trays, paper drawers, and other mechanisms of the printer 102 that the user can open, close, or otherwise operate. Operation of any of the user-operable mechanisms 308 may constitute an event that causes the camera 305 to record activity. Likewise, the motion detector 310 detecting motion around the printer 102 may constitute an event that causes the camera 305 to record activity.

The time mechanism 312 is another optional component of the printer 102. The time mechanism 312 may be an internal date and time clock, or a mechanism that enables the printer 102 to otherwise obtain the current date and time. The time mechanism 312 can be used for at least one of three purposes. First, it can be used so that the resulting data recorded by the camera 305 is timestamped with the current date and time. Second, the time mechanism 312 can be used so that external activity around the printer 102 is recorded only at certain dates and times, between preset and user-adjustable starting and ending times. For instance, during weekday business hours, when many individuals are likely to be around, the activity-recording ability of the camera 305 may be turned off. The camera 305 may only record activity in this case in response to events that occur during weekday non-business hours, and on the weekend.

Third, the time mechanism 312 can be used to generate its own events that cause the camera 305 to record the external activity around the printer 102. For example, every fifteen minutes, every hour, or at other regular intervals, the time mechanism 312 may instruct the camera 305 to record the external activity around the printer 102, regardless of whether other events are occurring. In this way, there will at least be regular recordings of the external activity around the printer 102, in addition to the recordings that occur as a result from user activation of the controls 306, user operation of the mechanism 308, and/or motion detection by the motion detector 310.

Other optional components of the printer 102 include the storage 314 and the communication mechanism 316. The storage 314 stores the data files generated by the camera 305 when recording external activity, where an external storage is not present or not desired to be used to store the data files. The communication mechanism 316 allows the printer 102 to communicatively couple with a network. It is optional only in the sense that clients may otherwise communicate with the printer 102 by being directly connected to the printer 102, rather than indirectly connected to the printer 102 over the network.

Finally, the internal server mechanism is also an optional component of the printer 102. The internal server mechanism 318 allows the printer 102 to, among other functionality, manage access to the stored files of recorded external activity by network administrators and other authorized personnel, where the printer 102 is desired to manage such access. That is, the internal server mechanism 318 allows for communication over a network with networked computerized devices of such users so that they can view the external activity as recorded by the camera 305. The printer 102 may also include other components than those described herein, as can be appreciated by those of ordinary skill within the art.

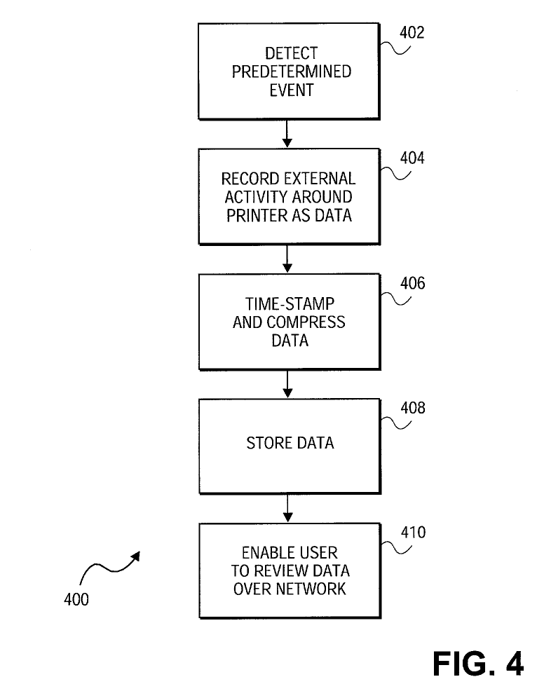

FIG. 4 shows a method 400 according to an embodiment of the present invention. The method 400 may be performed in conjunction with the printer 102 of FIGS. 1A-1C, 2, and 3, and the system 200 of FIG. 2, that have been described. The method 400 may also be implemented as a computer program, which may or may not be implemented in the firmware of a printer. The computer program can be stored on a computer-readable medium, for execution by a printer or other computerized device. The computer-readable medium may be a floppy disk, an optical disc such as a CD-ROM, a semiconductor-based memory such as read-only memory (ROM), random-access memory (RAM), flash memory, and so on, as well as any other type of computer-readable medium.

First, a predetermined event is detected (402). This event can be the detection of activity around a printer by a motion detector disposed at the printer, the detection of utilization of a user-activated control and/or a user-operable mechanism of the printer, and so on, as has been described. In response to detection of the event, external activity around the printer is recorded as data using a camera (404). As has been described, the camera may be a still-image or a moving-images camera, such that the data records one or more pictures or video, respectively, of the external activity. The data is preferably timestamped and compressed (406), and is then stored at a storage either internal or external to the printer (408). Finally, a user, such as a network administrator, is enabled to review the data over a network (410), via the user directly accessing the external storage him or herself, or accessing an internal server of the printer.

It is noted that, although specific embodiments have been illustrated and described herein, it will be appreciated by those of ordinary skill in the art that any arrangement is calculated to achieve the same purpose may be substituted for the specific embodiments shown. For example, although the various embodiments described herein have been with reference to a printer, such as a laser, inkjet, or other type of printer, any suitable image-forming device may be used. This application is intended to cover any adaptations or variations of the present invention. Therefore, it is manifestly intended that the scope of the present invention be limited only by the claims and equivalents thereof.

I claim:

1. An image-forming device comprising:
a case;
an image-forming mechanism disposed within the case; and,
an event-driven camera disposed at the case to record external activity around the image-forming device.

2. The image-forming device of claim 1, wherein the event-driven camera comprises a video camera capable of recording video of the external activity around the image-forming device.

3. The image-forming device of claim 1, wherein the event-driven camera comprises a still camera capable of recording still images of the external activity around the image-forming device.

4. The image-forming device of claim 1, further comprising one or more user-activated controls and user-operable mechanisms disposed at the case, utilization of one of the user-activated controls and the user-operable mechanisms constituting an event causing the event-driven camera to record the external activity around the image-forming device.

5. The image-forming device of claim 1, further comprising a motion detector disposed at the case, detection of motion by the motion detector constituting an event causing the event-driven camera to record the external activity around the image-forming device.

6. The image-forming device of claim 1, further comprising a time mechanism capable of providing a current time, such that the event-driven camera only records the external activity when the current time is between a preset and user-adjustable starting time and a preset and user-adjustable ending time.

7. The image-forming device of claim 1, further comprising a storage to store the external activity recorded by the event-driven camera.

8. The image-forming device of claim 1, further comprising a communication mechanism to send the external activity recorded by the event-driven camera over a network to an external storage.

9. The image-forming device of claim 1, further comprising an internal server mechanism with which a user is able to communicate via a networked computerized device over a network to view the external activity as recorded by the event-driven camera.

10. The image-forming device of claim 1, wherein the event-driven camera is at least one of: tamper-proof, hidden, and substantially undetectable.

11. A method comprising:
detecting a predetermined event; and,
in response to detecting the predetermined event, recording external activity around an image-forming device as data.

12. The method of claim 11, wherein detecting the predetermined event comprises detecting utilization of one of a user-activated control and a user-operable mechanism of the image-forming device.

13. The method of claim 11, wherein detecting the predetermined event comprises detecting motion around the image-forming device.

14. The method of claim 11, further comprising performing at least one of time-stamping the data and compressing the data.

15. The method of claim 11, further comprising storing the data and enabling a user to review the data over a network.

16. The method of claim 11, wherein detecting the predetermined event and recording the external activity is performed only when a current time is between a preset and user-adjustable starting time and a preset and user-adjustable ending time.

17. A computer-readable medium having a computer program stored thereon to perform a method comprising:
detecting activity around an image-forming device by a motion detector disposed at the image-forming device;
detecting utilization of one of a user-activated control and a user-operable mechanism of the image-forming device;
in response to detecting at least one of the activity around the image-forming device and the utilization of the one of the user-activated control and the user-operable mechanism of the image-forming device,
recording the external activity around the image-forming device with a camera as data;
storing the data; and,
enabling a user to review the data over a network.

18. The medium of claim 17, wherein recording the external activity around the image-forming device with the camera as the data comprises recording the external activity around the image-forming device with a video camera as data representing video of the external activity.

19. The medium of claim 17, wherein recording the external activity around the image-forming device with the camera as the data comprises recording the external activity around the image-forming device with a still camera as data representing still images of the external activity.

20. The medium of claim 17, the method further comprising, prior to storing the data, performing at least one of: timestamping the data and compressing the data.
